(19) United States
(12) Patent Application Publication
(10) Pub. No.: US 2004/0093556 A1
(43) Pub. Date: May 13, 2004

(54) Method and device for exchanging information

(76) Inventor: Daniel Gens, Bad Schwalbach (DE)

Correspondence Address: M. Robert Kestenbaum, 11011 Bermuda Dunes NE, Albuquerque, NM, 87111, US

(21) Appl. No.: 10/381,300

(22) PCT Filed: Sep. 20, 2001
(86) PCT No.: PCT/EP01/10880

(30) Foreign Application Priority Data
Sep. 26, 2000 (EP) 00120914.7

(51) Int. Cl. G06F 17/00

(52) U.S. Cl. 715/500

(57) ABSTRACT

So that a method and an apparatus for transmitting information which a sender has sent to at least one receiver provide, regardless of the type of information sent, fast and inexpensive transmission which can be handled by the sender, in particular, without any added involvement and which provides data which can be processed further by the receiver without significant additional involvement, provision is made for the information to be received in a first device and converted into electronic data, for the electronic data to be transmitted to the at least one receiver, and for the electronic data with the receiver to be provided in a form which can be selected by the receiver.

### DESCRIPTION

The invention relates generally to a system for transmitting information and specifically to a method for transmitting information in line with the precharacterizing part of claim 1 and to an apparatus for transmitting information in line with the precharacterizing part of claim 22.

Countless methods of transmitting information are known. In this context, one of the best-known and most frequently used methods is still the classical sending and receiving of letters. Although the physical sending of the written item means that this involves the receiver often having authentic information available, this information is not suitable for subsequent further processing, for example in electronic form, and, if such further processing is necessary, generates high costs as a result of the manual recording or scanning and subsequent processing of scanned texts. In addition, the physical transport of the written item is time consuming and is in many cases no longer able to meet the demands of rapid information exchange.

Although sending written items by fax is faster and, during data transmission, results in an electronic replica of the information contained in the written item, this electronic replica or a corresponding printout from the fax machine is also generally not suitable for further electronic processing of the information by a receiver.

In addition, an electronic letter-sending system corresponding to conventional mail has existed for some considerable time, said letter-sending system being referred to as electronic mail or e-mail. This involves data being interchanged between computer systems which communicate with one another over a network or a group of networks. In this case, it is possible for data to be interchanged between different computer systems, for example between personal computers. The functional sequences in such an e-mail system are dependent on the respective operating systems installed on the computer systems which communicate with one another. In this case, the e-mail system is intended to provide a smooth transition between various operating systems as a result of conversion programs. In addition, e-mail systems today have particular user functions. Thus, the arrival or the reading of a message at the receiver end can trigger an acknowledgement confirming this to the sender of the message. The data to be sent can be produced either by using editors provided by the respective e-mail system or by importing computer files generated using other word processing systems. In this context, the latter are sent as “attached files” (ANNEX file) in the conventional e-mail systems. Unfortunately, these attached files are frequently transmitted to the systems used at the receiver end with nothing but problems and involvement for the receiver end. The problems result from the different data structures or contents of the transmission and reception systems. The cause of the differences is frequently the varied nature of the software and hardware used. An example of this is data transmission from a KHK invoice program to SAP R3. Particularly with regard to the control symbols used for printer control or formatting, this situation is a candidate for misinterpretation which can put the structure of the files into disorder.

Besides the purely electronic letter-sending systems described above, there is also a hybrid form combining electronic mail and conventional sending in an envelope. This “hybrid mail system” involves the sender's data being electronically transmitted to a central processor unit, where they are printed in line with the sender's additionally delivered information, and these printed data then being sent to the receiver conventionally by mail in an envelope. However, the receiver-end process of printing and conventionally distributing the data continues to be very time consuming. In addition, there is no way of electronically processing the data further at the receiver end. Furthermore, producing a printed image prescribed by the sender in a central processor unit is difficult and is frequently no longer equivalent to what was imagined by the sender.

The invention is therefore based on the object of providing a universal system for transmitting information which alleviates the above drawbacks and, particularly regardless of the type of information sent, affords fast and inexpensive transmission which can be handled without any additional involvement, particularly for the sender, and provides the receiver with data which can be processed further without any significant additional involvement.

The object is achieved in a surprisingly simple manner merely by a method having the features of claim 1 and an apparatus having the features of claim 22.

The invention has the great advantage that the data sent are available at the receiver end in the manner in which they were provided by the sender's data processing environment without there being any complications along the way if entirely different systems are used by the sender and the receiver.

The invention provides the user with a direct connection between the sender and receiver which, regardless of the technical equipment used, is both able to be provided with the written image used and with the chosen page structure and holds data which can be put directly to further use.

A fundamental concept of the invention is that an almost standard form of the data to be transmitted is provided at the sender's end from a wealth of different representation options resulting from the large number of possible items of equipment which can be used. By way of example, this can be done by virtue of the data sent to a printer being received and converted into a virtual document which retains all the necessary information for the page structure. In this context, a specific printer driver provides the electronic interface to the virtual paper document. Since large companies produce appropriate printer drivers for almost all word processing systems, this makes it possible to provide a simple electronic interface for any text systems. In addition, data available in fax form, as generated when sending faxes or when scanning in documents, for example, can likewise be constructed to produce virtual pages of a virtual document. In these cases, downstream OCR or character recognition software can provide electronic data which can be used further.

Advantageously, framework data containing structure information and/or processing information relating to the data are also transmitted with the information. In addition, forwarding can be done entirely electronically if, by way of example, character recognition or corresponding association of the data provides receiver address data for electronic addressing.

Particularly advantageously, an electronic portal located in the network or in a group of networks can receive the data, store them and forward them as appropriate taking into account the respective prescribed security levels. Such a portal can comprise a plurality of selectable units (selection units) undertaking the electronic forwarding and reception in the form of nodes, but is implemented by the user preferably as just a “large electronic post office”. However, the provision of additional processing information allows transmission to a selection unit which is as optimally suited as possible in the group of networks, and allows the selection unit to hold the data for the at least one receiver on the basis of the processing information.

The processing information can advantageously contain further details about the receiver or receivers, such as details about the type and time of forwarding or the security level which is to be observed.

The processing information can also contain an instruction sequence which triggers a reception signal to the sender on the basis of the data's being delivered to the at least one receiver.

In addition, the structure information advantageously contains a description of the structure of the data. In this case, the description also contains control information relating to the structure of the printed image at the receiver's location. Hence, a “virtual printed document” is advantageously sent and received. The transmitted data are thus redundant.

The data transmitted can be pure text files, image files, mixed files or invoice or order forms essentially comprising numbers, without the user experiencing any kind of limitation. It is also possible to use the inventive method for automated production and sending of telephone bills or credit card bills. Another advantage in this context is automated electronic monitoring of receipt of a payment when a printed payment slip is simultaneously available.

The invention thus also affords the advantage that the receiver end or sender end does not repeatedly have to change an electronic data record into printed documents generated therefrom or perform conversion in the opposite direction.

A protection mechanism can advantageously be used to protect the information to be transmitted from unauthorized reading and/or data manipulation. In this case, the protection can be provided by voice recognition and/or handwriting authentication. In addition, the protection can be provided by specifying a prescribable code word. Digital watermark.

In line with the invention, a security identifier comprising data for protection and for use can respectively be carried for the information and/or for the structure information and/or for the processing information. In this case, the individual security identifiers can be designed to be independent of one another or can be logically combined with one another. Advantageously, a hierarchic access structure can thus be constructed for the data.

In the case of one variant of the inventive method, the data are transmitted with test sequences for controlling flow. Alternatively, test data for a check can be transmitted at prescribed intervals. In the inventive method, the sender and the at least one receiver are registered with the selection unit. It is thus advantageously possible to present an identifier which can be automatically checked using the processing information. In line with the invention, the connection to the receiver can be made in various ways.

Thus, the data can be read from the selection unit using radio-operated terminals. The receiver or receivers can optionally also use optically connected terminals to read data from the selection unit or to return data to said selection unit. This results in direct unlimited access options which do not impair the editing quality of the data, however.

It is thus possible, by way of example, for the presence of a transmission to be indicated to a receiver on his mobile phone and for the receiver, by way of example, to be able to receive and read said transmission, for example to be able to read it in the WAP standard and to prompt the appropriate forwarding, without this adversely affecting the quality of the subsequently received transmission.

The invention is explained in more detail below using a preferred exemplary embodiment with reference to the appended drawing, in which:

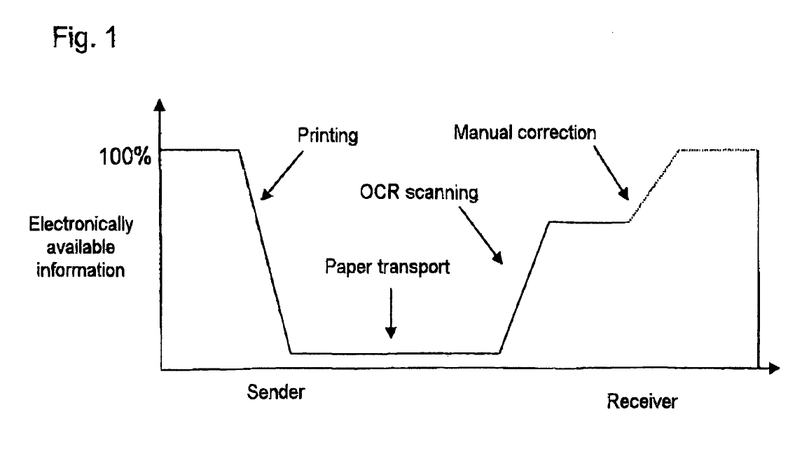

FIG. 1 shows an illustration of the loss of information during conventional information exchange made on paper, as when sending a letter or a fax,

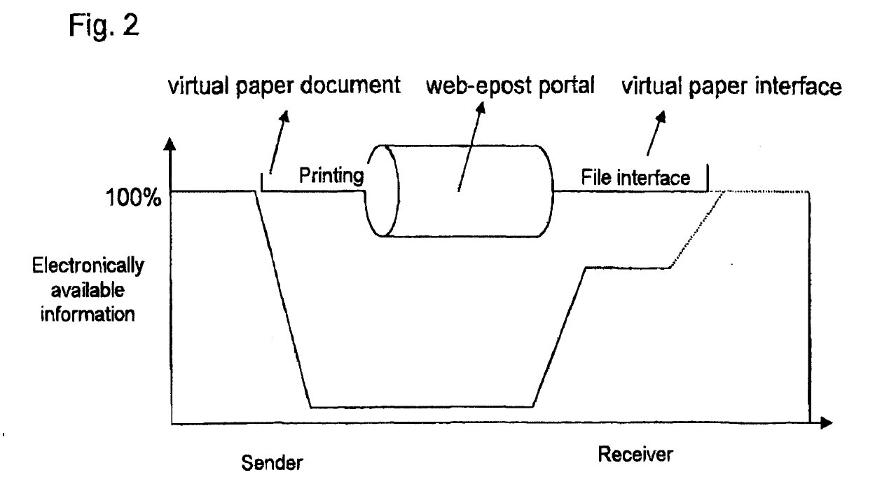

FIG. 2 shows an illustration of the inventive transport of information, where the use of a virtual paper document results in essentially no loss of information,

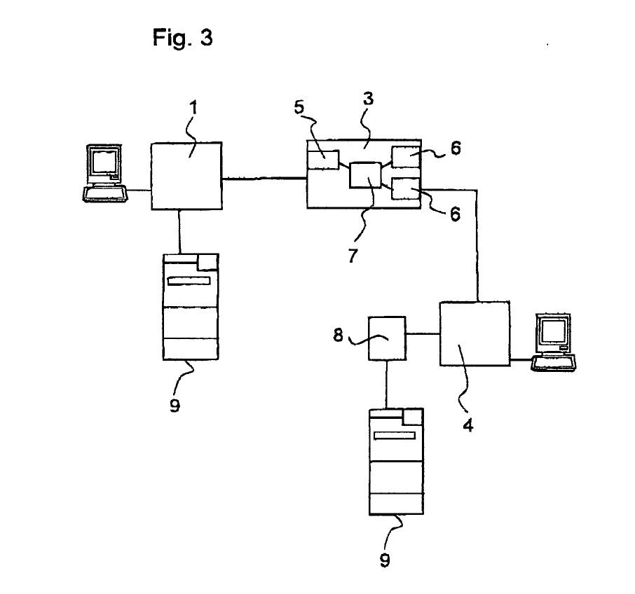

FIG. 3 shows a schematic illustration of an inventive data transmission device.

The invention is described below, without limiting its general nature, first with reference to a preferred embodiment, with an explanation first being given of the previous situation and of definitions and terms used in the description, for the purpose of better understanding.

FIG. 1 clearly shows the loss of information which can be processed further which occurs when sending written, user-related information by letter or fax as previously. The printing operation first reduces the electronically available information at the sender's location to almost zero, and although the receiver end has physically archivable written items available even in the case of a fax transmission, no data which can immediately be processed further are available. Only time-consuming and error-prone scanning-in of the written item with subsequent error correction reproduces a data record which allows receiver-specific evaluation. In this context, however, a not inconsiderable level of personnel costs is incurred

FIG. 2 shows how the basic concept of the present invention can easily be implemented, and the text below first describes basic technical concepts of the invention before giving a detailed description of the preferred exemplary embodiment.

Right from a very early time, that is to say either when the print data are made available to a printer or, by way of example, when fax signals or an e-mail attachment is/are sent, a virtual paper document is produced which comprises all the user-related information. This means that both all the contents of the written information and all data relating to form are recorded and forwarded independently of system.

The electronic portal or electronic post office, referred to as web-epostviper portal, which is on the Internet or in an intranet, receives these data and, in one very simple embodiment, makes these data available to a receiver or undertakes transmission to the receiver itself.

At the receiver's location, the virtual paper document is converted into any desired output form, for example a printable file or a fax reception signal which results in corresponding written information with no losses of content or form in the two-dimensional representation. In all cases, the virtual paper document comprises all user-related information in an electronic, further-processable form.

The invention thus also comprises a platform for exchanging data-format or structure descriptions. The receiver produces one or more descriptions of how he can receive data in his system. This description is stored in the viper system (described in more detail below), which is a unit which can be selected on the Internet or in an intranet, at said viper system's address. This selectable unit is also referred to as a selection unit below. As part of the virtual paper, the sender likewise sends the description of the transmitted data or the structure. The viper system carries out automatic or assisted alignment of the two formats.

One possible embodiment of the descriptions is provided using a description language, for example XML.

Example of such a description of the formats:

Sender:

| | |
|---|---|
| Invoice No | 5 places numerical |
| Invoice data | 6 places data item |
| Total | 10.2 places double |
| Receiver: | |
| Supplier No | 8-place numerical |
| Invoice No | 10-place numerical |
| VAT | 7.2 places double |

The alignment process is iterative and continues until all the data required at the reception end are available and are in the defined format. For this purpose, the viper system sets up a two-way communication link to the receiver using an intranet connection or Internet connection or by directly dialing up a receiver-end modem, and interchanges all data required for describing the receiver format step by step.

Throughout the entire transmission chain, there is thus neither any loss of electronically available information nor any additional demand on the users, since appropriate interfaces respectively allow use of the devices already available.

In the case of one preferred practical embodiment of the invention, all this is realized as described below. Reference is made to FIG. 3, in which the sender produces information to be transmitted preferably using a personal computer which is connected to a first electronic device 1 communicating with a selection unit 3 in the Internet portal, the viper system. The personal computer can be connected using a network connection, a serial or parallel data link, optically or else using a remote data transmission interface by modem, preferably by digital modem, for example by ISDN modem. Although the electronic device 1 is thus advantageously arranged at the sender's location, this is not necessarily so. The same applies for the electronic device 4 at the receiver's location.

The sender can use any conventional text data processing system which he also uses to edit his specific sender data, for example the representation of a company logo and/or the address, inter alia with e-mail addresses or telephone numbers.

When the information has been produced in a word processing system or data processing system, it can be stored in a file. The file can then be printed on a printer available at the sender end, and any errors can be corrected by checking the printed image.

The sender can then use a conventional e-mail system to transmit the printable data corresponding to the printed version 2, a “virtual printed document”, directly to an electronic portal, for example to the web-epostviper portal from FIG. 2, using a selection unit 3 or can send these data to the first electronic device 1, which has a printer input interface and carries out forwarding automatically. Preferably, the selection unit 3 is respectively connected to the sender and to at least one receiver by means of an intranet or the Internet.

In another refinement of the invention, the sender's electronic device 1 and the receiver's electronic device 4 comprise, in each case optionally, a data terminal interface which transmits data which have been sent by analog or digital fax, with text components which can be processed further using character recognition software also being created for this data type and being processed, having been provided with an appropriate format description, to produce a virtual document which is made available to the receiver in parallel with reception of the fax as a further-processable electronic document in the same way as the data record which was produced by the word processing system and converted to produce a virtual document.

In addition, the electronic devices 1 and 4 optionally have a scanner interface in order to be able to transmit and convert data which are already available as two-dimensional data on paper or on a film.

To allow communication between the personal computer and the device 1 or 4, an infrared interface or else an interface based on the Bluetooth standard can also be used.

In one particularly preferred embodiment of the present invention, the selection unit 3 is in the form of an Internet portal. An Internet connection is used to provide contact between the receiver and the selection unit 3. To this end, the selection unit 3 has one or preferably more outboxes 6 in addition to an inbox 5. A file arriving from the sender 1 is temporarily stored in the inbox 5.

Preferably, a processor 7 provided in the selection unit 3 checks the incoming file for receiver-specific information and reads said file if said information is present. The processor 7 then prompts transfer of the file to an address in line with the receiver-specific information contained in the file, for example an e-mail address for the receiver.

Preferably, the file is read into the outbox 6 associated with the receiver 4 by the processor 7. The receiver 4 then receives a message stating that his associated outbox 6 in the selection unit 3 provided in the group of networks is holding a file. This message is sent as an e-mail and/or also as a call to a [lacuna] with SMS or WAP capability.

The receiver can now return an electronic identifier to the selection unit 3 in order to gain access to the outbox 6 and to read the data therein. The data read in this way are then converted at the receiver end into a printed version 9 in the data processing environment 8 existing at the receiver end.

This conversion can be performed either in the receiver's data processing device 8 or in an upstream second electronic device 4 at the receiver's location.

For the purpose of conversion, the structure information is checked and control symbols contained therein are sent to the receiver-end printer drivers. If alignment with the receiver-end data processing environment 8 is necessary, this is can be done dynamically using a formatting record which is likewise appended to the data. In line with the invention, the printed version 9 produced at the receiver end is identical to that 2 which has been produced in the sender's data processing environment. Thus, by way of example, the company logo which has been input by the sender, for example, has been transmitted identically. The other information contained in the file, such as a full invoice data record in a payable invoiced amount, is also available at the receiver end without any manipulation in the printed version 2 of the file.

In addition, the invention provides for the receiver 4 to present an electronic password to gain direct access to the data. Thus, by way of example, the receiver can read an invoiced amount entered in the file directly into an invoice or accounting program in his data processing environment 8 electronically.

If a payment transaction needs to be confirmed at the sender end, the receiver 4 can use the inventive method to return a corresponding payment instruction which he has carried out to the sender 1. In this case, he can produce a printed image 9 of the payment instruction in his data processing environment 8. This printed image which he has produced is identical to that 2 which is produced, following transmission of the data to the sender, in the sender's data processing environment using an ordinary print operation.

When a reading and further-processing operation is carried out by the receiver 4, the selection unit 3 can be used for optionally transmitting to the sender 1 a confirmation which is roughly equivalent to a receipt for a registered letter sent conventionally by mail.

This confirmation can also be provided with a digital watermark which confirms the identity of the receiver and thus indicates to the sender 1 that the data have been transmitted correctly.

The invention is not limited to the exemplary embodiment described, which can be modified in a wide variety of ways. Thus, within the context of the present invention, access can be gained in extremely diverse ways both at the receiver end and at the sender end. Thus, besides a conventionally networked computer or a data processing unit, access is also possible using a radio telephone (mobile phone) or, by way of example, using a portable computer (laptop) equipped with a modem and using corresponding derivatives, such as a palmtop or an organizer.

The invention also covers the electronic device 4 using a fax interface in the device 4 to output the data and to edit them at the receiver end.

Without any limitation of the general nature, the receiver in the exemplary embodiment described can also be the sender, since the invention describes a two-way system.

The inventive method can also be used between a plurality of senders and/or receivers, with the accordingly necessary duplication being performed by the selection unit 3.

As described above, one simple embodiment of the invention can consist in a pure software solution if the data produced as printed data are converted by the software to produce a virtual document and are sent to the selection unit 3. In this case, the personal computer at the sender end and at the receiver end is not connected to the respective electronic device 1 or 4 but rather directly to the network for the selection unit 3.

On the other hand, realization of the invention on the basis of a more hardware-oriented solution can simply involve the electronic devices 1 and 4 being connected to the hardware already existing for the sender or receiver, and this hardware then undertaking the whole of the communication. In this context, by way of example, the electronic device 1 or 4 can be assigned a particular printer in the word processing program or a particular telephone number in the fax machine, which means that the data can then be supplied to the selection unit 3 automatically.

Receivers can be indicated directly in the text fields on the written item produced by the user, and the selection unit 3 therefore automatically provides the receivers with the information as specified by the user. Alternatively, particular receivers can be assigned particular telephone numbers or printers which can be selected in the text system, which then likewise results in forwarding to the associated receiver.

1. A method for transmitting information which a sender has sent to at least one receiver,
where
the information is received in a first device and is converted into electronic data,
the electronic data are transmitted to the at least one receiver,
characterized in that
a virtual paper document is produced
which, independently of system, comprises contents of the written information and data relating to form, and,
on the basis of the transmitted electronic data, data-format and/or structure descriptions are exchanged,
such that the virtual paper document with the receiver is implemented in a form which can be selected by the receiver.

2. The method for transmitting information as claimed in claim 1, in which
the information to be transmitted is converted from any
two-dimensional or electronic form into electronic data which are transmitted on a network or a group of networks to the at least one receiver.

3. The method for transmitting information as claimed in claim 1 or 2, in which
the freely selectable form of data reproduction includes the display of the data on a monitor or on a data reproduction unit and also their being printed in two-dimensional form by a printer, preferably connected to a computer, or a fax machine, and
the data are reproduced in a standard output form without the form of data reproduction being selected by the receiver.

4. The method for transmitting information as claimed in one of claims 1, 2 or 3, in which
framework data containing data-related structure information and/or processing information are transmitted to a selection unit in the network or group of networks together with the information, and
the selection unit stores the data for the at least one receiver on the basis of the processing information and holds them ready for retrieval.

5. The method as claimed in claim 4, in which the processing information contains information about the at least one receiver.

6. The method as claimed in claim 4 or 5,
in which the processing information contains details relating to the type and time of forwarding to the at least one receiver.

7. The method as claimed in one of claims 4, 5 or 6, in which the processing information comprises an instruction sequence which triggers a reception signal to the sender on the basis of the data's being delivered to the at least one receiver.

8. The method as claimed in one of claims 4 to 7,
in which the processing information contains data relating to a request for access authorization.

9. The method as claimed in one of claims 4 to 8,
in which the structure information contains sender-specific data.

10. The method as claimed in one of claims 4 to 9,
in which the structure information contains a description of the structure of the electronic data.

11. The method as claimed in claim 10,
in which the description contains control information about the structure of a printed image.

12. The method as claimed in one of claims 1 to 11,
in which the electronic data are protected at least to some extent against unauthorized reading and/or data manipulation using a security identifier.

13. The method as claimed in claim 12,
in which the security identifier comprises data for voice recognition.

14. The method as claimed in claim 12 or 13,
in which the security identifier comprises data for handwriting authentication.

15. The method as claimed in claim 12, 13 or 14,
in which the security identifier comprises a code word.

16. The method as claimed in one of claims 12 to 15,
in which a security identifier is respectively produced and transmitted for the information which is to be transmitted and/or for the structure information and/or for the processing information.

17. The method as claimed in one of claims 1 to 16,
in which the data contain test sequences.

18. The method as claimed in one of claims 1 to 17,
in which at least one first device or the selection unit transmits test data at prescribed intervals.

19. The method as claimed in one of claims 4 to 15,
in which the sender and the at least one receiver are registered with the selection unit together with data about the security identifier.

20. The method as claimed in one of claims 4 to 19,
in which the at least one receiver can read the data from the selection unit using radio-operated terminals, particularly mobile radios.

21. The method as claimed in one of claims 1 to 20, in which
the first device generates electronic data which correspond to a virtual page or to a virtual document having a plurality of virtual pages, and
the second device uses the electronic data for a virtual page to produce respective data for a two-dimensional replica, where the data for the two-dimensional replica comprise, depending on the selection of the form of reproduction by the receiver:
i) data which can be received by a fax machine,
ii) editable data formatted for a selected text system or data processing system,
iii) data formatted so that they can be printed correctly by a particular printer.

22. An apparatus for transmitting information, particularly for carrying out a method as claimed in claims 1 to 21, in which a sender has sent the information to at least one receiver, which is characterized by
a first electronic device (1) which receives the information and converts it into electronic data,
where, on the basis of the converted electronic data, the first electronic device (1) produces a virtual paper document which, independently of system, comprises contents of the written information and data relating to form, and
a second electronic device (4) which, on the basis of the transmitted electronic data with the receiver, exchanges data-format and/or structure descriptions,
such that the virtual paper document is implemented in a form which can be selected by the receiver.

23. The apparatus for transmitting information as claimed in claim 22, in which the first device (1) comprises a printer interface, a data terminal interface for connecting a data terminal, particularly a fax machine, to the analog telephone network, a data terminal interface for connecting a data terminal, particularly a fax machine, to the digital telephone network, and/or a scanner interface.

24. The apparatus for transmitting information as claimed in claim 23, in which the information to be transmitted in the first electronic device (1)
is received at the printer interface if it has been generated from a text or data processing system,
is received at the data terminal interface if it has been sent by analog or digital fax, and/or
is received at the scanner interface if it is in the form of two-dimensional data on paper or on a film.

25. The apparatus as claimed in claim 24, in which the received data in the first electronic device (1) are converted into a data format which corresponds to a virtual page or to a virtual document having a plurality of virtual pages and are sent to the second electronic device (4) and/or to a selection unit (3), and are provided in a standard output form without the output form being selected by the receiver.

26. The apparatus for transmitting information as claimed in claim 22, 23, 24 or 25, in which
the second device (4) comprises a monitor, preferably for a personal computer, or a data reproduction unit for displaying the transmitted data edited in the second electronic device (4) or in the selection unit, and/or
comprises a printer or a fax machine for printing the data in two-dimensional form.

27. The apparatus for transmitting information as claimed in one of claims 22 to 26, in which
the first device (1) or the selection device (3) generates additional electronic data which contain framework data associated with the information,
where the framework data contain structure information and/or processing information relating to the electronic data.

28. The apparatus for transmitting information as claimed in one of claims 22 to 27, also comprising
a selection unit (23) in a network or a group of networks, to which selection unit the electronic data can be transmitted by the first device (1),
where the selection unit (3) stores the data for the at least one receiver on the basis of the processing information and holds them ready for retrieval.

29. The apparatus for transmitting information as claimed in claim 27 or 28, in which the processing information contains details about the type and time of forwarding to the at least one receiver.

30. The apparatus for transmitting information as claimed in claim 27, in which
the selection unit (3) forwards the electronic data to a second electronic device (4), which is preferably situated at the at least one receiver's location, under the control of the processing information.

31. The apparatus for transmitting information as claimed in one of claims 22 to 30, in which
the second electronic device (4) and/or the selection unit (3) extracts data relating to a request for access authorization from the processing information and makes an access authorization request on the basis of these data.

32. The apparatus for transmitting information as claimed in one of claims 22 to 31, in which a memory area in the selection unit (3) and/or in the second electronic device (4) stores data relating to the sender and the at least one receiver together with data about the security identifier, preferably in encrypted form.

33. The apparatus as claimed in one of claims 22 to 32, in which the selection unit (3) and/or the second electronic device (4) comprises a character recognition unit which can be used to convert handwritten information available in digitized form into digital text data.

34. The apparatus as claimed in claim 33, in which the selection unit (3) obtains control data from the digital text data in order thus to prompt forwarding to a particular receiver or storage of the data.

35. The apparatus as claimed in one of claims 22 to 34, in which the selection unit (3) and/or the second electronic device (4) comprises a radio interface which is used to generate data suitable for mobile reception, particularly SMS or WAP formatted data, from the information to be transmitted and to transmit them to the at least one receiver.

36. The apparatus as claimed in claim 35, in which the data which are SMS or WAP formatted, in particular, are transmitted upon request by a radio-operated terminal, particularly a mobile radio.

37. The apparatus as claimed in one of claims 22 to 36, in which the second electronic device has an infrared interface which can be used to read the received electronic data using optically connected terminals.

38. The apparatus as claimed in one of claims 22 to 37, in which the second electronic device has an interface based on the Bluetooth standard which can be used to read the received electronic data using connected terminals.
